(19) United States
(12) Patent Application Publication
(10) Pub. No.: US 2025/0080490 A1
(43) Pub. Date: Mar. 6, 2025

(54) Method of NAT64 Translation

(71) Applicant: MediaTek Singapore Pte. Ltd., Singapore (SG)

(72) Inventors: Konark Mehra, Noida (IN); Pranav Kumar Ghosh, Noida (IN)

(73) Assignee: MediaTek Singapore Pte. Ltd., Singapore (SG)

(21) Appl. No.: 18/540,927

(22) Filed: Dec. 15, 2023

(30) Foreign Application Priority Data
Aug. 29, 2023 (IN) 202321057813

(51) Int. Cl. H04L 61/251; H04L 61/2521

(52) U.S. Cl. CPC H04L 61/251; H04L 61/2525

(57) ABSTRACT

A method of NAT64 translation includes discovering NAT64-Prefix by an IPv6 host, generating IPv4 connectivity by a customer-side translator (CLAT) device according to NAT64-Prefix, notifying the IPv4 connectivity to a private IPv4 (v4p) host, and notifying IPV4 header configuration to the v4p host by the CLAT device. The IPV4 header configuration includes a header length. The method further includes increasing a header length of the IPv4 header by the v4p host.

### BACKGROUND

Internet Protocol version 4 (IPv4) and Internet Protocol version 6 (IPv6) are two different versions of the Internet Protocol (IP), which is the set of rules that govern how devices communicate on the Internet. IPv4 is the older version of the protocol, and it is currently used by most devices on the Internet. IPv4 and IPv6 are not compatible with each other, such that devices using one protocol cannot communicate directly with devices using the other protocol. Because many devices still use IPv4, but the IPv6 infrastructure is growing, protocol communication becomes a problem.

Due to the IPv4 network address space becoming exhausted, communications network operators are moving to deploy IPv6 networks. The Third Generation Partnership Project (3GPP) has defined standards for specifying possible migration techniques for operators when changing their mobile core networks from IPv4 to IPv6. However, as the majority of mobile core networks, and other communication networks such as the Internet, are still based on IPv4.

There are several of technologies for interworking between IPv4 to IPv6: dual stack, tunneling and translation. As for translation, there are a number of different technologies that can be used to translate between IPv4 and IPv6, but the most common is Network Address Translation (NAT). NAT is a technique that allows a single public IP address to be shared among multiple devices. This is done by translating the private IP addresses of the devices into a single public IP address. When an IPv4 device tries to communicate with an IPv6 device, the NAT device translates the IPv4 address to an IPv6 address. The IPv6 device then sends the packet to the destination IPv6 device. The process is reversed when the IPv6 device tries to communicate with the IPv4 device.

NAT64 is another standard transition mechanism defined by the Internet Engineering Task Force (IETF) for IPv6 deployment. NAT64 is a technique that enables communication between IPv6 and IPv4 hosts by using a form of network address translation (NAT). NAT64 was developed as a solution for the IPv4 address exhaustion problem and the coexistence of IPv4 and IPv6 networks. NAT64 works by translating the IPv4 addresses of the hosts in one network to IPv6 addresses that can be routed in another network, and vice versa. NAT64 can be implemented in two ways: stateless or stateful. Stateless NAT64 uses a fixed algorithm to map the IPv4 addresses to IPv6 addresses, while stateful NAT64 maintains a dynamic binding table that records the mappings between the IPv4 and IPv6 addresses. NAT64 requires a gateway device that performs the translation and a DNS64 server that synthesizes the IPv6 addresses for the IPv4-only hosts. NAT64 can be used for different scenarios, such as allowing IPv6-only clients to access IPv4-only servers, or allowing IPv4-only clients to access IPv6-only servers.

Due to the different length of the IPv4 and IPv6 headers, which are 20 plus bytes and 40 bytes respectively, handling the maximum packet size is critical for the operation of the IPv4 and IPv6 translation. RFC 6145 defines three mechanisms to handle packet mismatch between IPv4 and IPv6 headers: path MTU discovery (PMTUD), fragmentation, and transport-layer negotiation such as the TCP Maximum Segment Size (MSS) option. However, the document (RFC 6145) does not specify any mechanism to manage overheads (e.g., read and write operations) of the translation. Therefore, a solution is needed to reduce the need for memory read and write operations, improve translation speed, and reduce memory requirement for buffer translator function.

### SUMMARY

An embodiment provides a method of NAT64 translation. The method includes discovering NAT64-Prefix by an IPv6 host, generating IPv4 connectivity by a customer-side translator (CLAT) device according to NAT64-Prefix, notifying the IPv4 connectivity to a private IPv4 (v4p) host, and notifying IPv4 header configuration to the v4p host by the CLAT device. The IPv4 header configuration includes a header length. The method further includes increasing the header length of the IPv4 header by the v4p host.

Another embodiment provides a method of NAT64 translation. The method includes generating an IPv4 packet by a private IPv4 (v4p) host. The IPv4 packet includes an IPv4 header with dummy options and a payload. The method further includes sending the IPv4 packet from the v4p host to a customer-side translator (CLAT) device, translating the IPv4 header and the dummy option to an IPv6 header, by the CLAT device, to generate an IPv6 packet, and sending the IPv6 packet, by the CLAT device, to an IPv6 network.

Another embodiment provides a method of NAT64 translation. The method includes generating an IPv4 packet by a private IPv4 (v4p) host. The IPv4 packet includes an IPv4 header with dummy options and a payload. The method further includes sending the IPv4 packet from the v4p host to the customer-side translator (CLAT) device, translating the IPv4 header and the dummy option to an IPv6 header and a fragmentation header to generate an IPv6 packet, and sending the IPv6 packet to an IPv6 network.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an exemplary NAT64 translation system of an embodiment.

FIG. 2 is flowchart illustrating a method of NAT64 translation implemented in accordance with the NAT64 translation system of FIG. 1.

FIG. 3 is a flowchart illustrating a method of NAT64 translation implemented in accordance with the NAT64 translation system of FIG. 1.

FIG. 4 is a diagram illustrating an exemplary translation of an IPv4 packet to an IPv6 packet of an embodiment.

FIG. 5 is a flowchart illustrating a method of NAT64 translation implemented in accordance with the NAT64 translation system of FIG. 1.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

For purposes of furthering understanding of the disclosure, some explanation is provided for numerous networking computing devices and protocols.

“464XLAT” refers to a technique for translating IPv4 addresses to IPv6 addresses. It is designed to be used when IPv6 devices need to communicate with IPv4-only servers. 464XLAT works by combining two different types of translation: stateful translation and stateless translation. Stateful translation is used to keep track of the mappings between IPv4 and IPv6 addresses, while stateless translation is used to translate addresses on a per-packet basis.

“464XLAT” architecture uses IPv4/IPv6 translation standardized in RFC 6145 and RFC 6146. It does not require DNS64 since an IPv4 host may simply send IPv4 packets, including packets to an IPv4 DNS server that would be translated to IPv6 on the customer-side translator (CLAT) and back to IPv4 on the provider-side translator (PLAT).

“IPv4 network” refers to a specific network that has an IPv4-only deployment. This could be an enterprise's IPv4-only network, an ISP's IPv4-only network, or even an IPv4-only host. The IPv4 Internet is the set of all interconnected IPv4 networks.

“IPv6 network” refers to a specific network that has an IPv6-only deployment. This could be an enterprise's IPv6-only network, an ISP's IPv6-only network, or even an IPv6-only host. The IPv6 Internet is the set of all interconnected IPv6 networks.

A “state” refers to dynamic information that is stored in a network element. For example, if two systems are communicating using a TCP connection, each stores information about the connection, which is called “connection state”. In this context, the term refers to dynamic correlations between IP addresses on either side of a translator, or tuples (e.g., IP address, transport protocol, transport port number) on either side of the translator. Thus, a stateful translation is a translation algorithm may be said to “require state in a network element” or be “stateful” if the transmission or reception of a packet creates or modifies a data structure in the relevant network element.

“NAT64” refers an IPv6 transition mechanism that facilitates communication between IPv6 and IPv4 hosts by using a form of network address translation (NAT). NAT64 is a stateful translation for transmitting a network address and a protocol, and usually merely supports an IPv6 network-side user to initiate to connect and access to an IPv4-side network resource. However, NAT64 also supports manual configuration of a static mapping relationship for active initiation of connection and access of an IPv4 network to an IPv6 network. NAT64 may implements IPv6 and IPv4 network address and protocol translation under a Transmission Control Protocol (TCP), a User Datagram Protocol (UDP) and an Internet Control Message Protocol (ICMP).

“PLAT” stands for provider-side translator (XLAT) that complies with RFC 6146. It translates global IPv6 addresses to global IPv4 addresses, and vice versa.

“CLAT” stands to customer-side translator (XLAT) that complies with RFC 6145. It algorithmically translates private IPv4 addresses to global IPv6 addresses, and vice versa. The CLAT function is applicable to a router or an end-node such as a mobile phone. The CLAT should perform IP routing and forwarding to facilitate packets forwarding through the stateless translation even if it is an end-node. The CLAT as a common home router or wireless Third Generation Partnership Project (3GPP) router is expected to perform gateway functions such as being a DHCP server and DNS proxy for local clients.

NAT64-Prefix refers to an IPv6 prefix used for IPv6 address synthesis. NAT64-Prefix is used by the NAT64 to construct IPv4-converted IPv6 addresses as defined in RFC 6052. It is possible to assign one or more NAT64-Prefix, each of them being equal to or even bigger than the size of the whole IPv4 address space. This allows each IPv4 address to be mapped into a different IPv6 address by simply concatenating a NAT64-Prefix with the IPv4 address being mapped and a suffix.

As used herein, a network function (e.g., IPv4 host, CLAT, etc.) may be a piece of network equipment, including hardware and software, that communicatively interconnects other equipment on a network (e.g., other network elements, end stations, etc.).

For terms and techniques not specifically described, reference may be made to communication standard documents (e.g., RFC documents and 3GPP specifications) issued before this specification, and more particularly to RFC 6052, RFC 6145, RFC 6146, RFC 6147 and RFC 6877.

In this specification, technical features that are individually described within one drawing may be implemented individually or simultaneously.

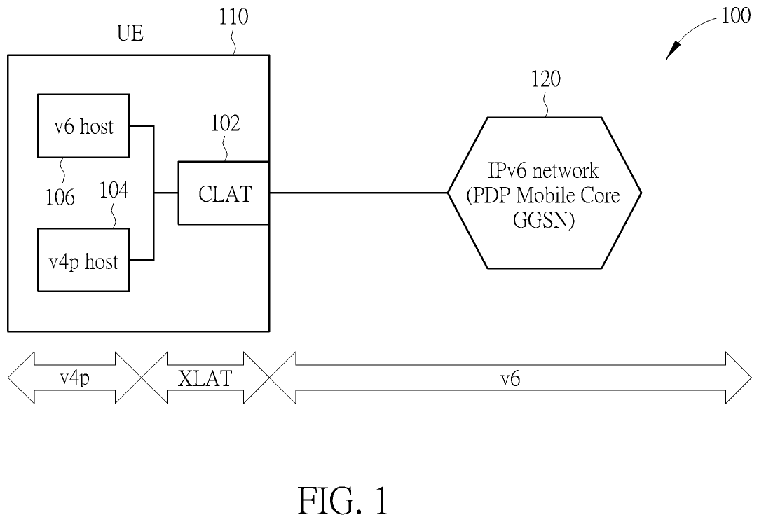

FIG. 1 is a diagram illustrating an exemplary NAT64 translation system 100 of an embodiment. The NAT64 translation system 100 may include user equipment (UE) 110 and an IPv6 network 120. The UE 100 may include a CLAT device 102, a private IPv4 (v4p) host 104 and an IPv6 (v6) host 106. The v4p host 104 and the v6 host 106 both may be associated with the CLAT device 102. In wireless 3GPP network architecture, for example, the IPv6 network 120 may include a Gateway GPRS Support Node (GGSN) and Serving GPRS support node (SGSN) under IPv6 Packet Data Protocol (PDP) architecture, and other components of the general packet radio service (GPRS) core network. The UE 110 may be any equipment having CLAT function (e.g., a router, customer premise equipment (CPE), a smartphone with an application processor, etc.).

It should be noted that the GPRS core network, which allows 2G, 3G and WCDMA mobile networks to transmit Internet Protocol packets to external networks such as the Internet, is merely an example. In 4G Long Term Evolution (LTE) mobile core network, Evolved Packet Core (EPC), comprised of different network entities that perform the packet-switched tasks is implemented. Packet Data Network Gateway (PDN-GW) and Serving Gateway may be implemented for the same function in 4G LTE. There are also well-known equivalent entities in 5G New Radio. It is not described herein for brevity.

The NAT64 translation system 100 may be implemented by wireline topology or wireless network. The invention is not limited thereto.

An IPv4 packet includes an IPv4 header and a payload. The IPv4 packet header contains information about the source and destination of the packet, as well as other information that is used to route the packet through the network. The header length is generally 20 bytes long and the header may contain the following fields:
Version: 4-bit field indicating the version of the IP protocol.
Header length: 4-bit field indicating the length of the IP header in 32-bit words. The minimum value for this field is 5, which indicates a length of 5× 32 bits=160 bits=20 bytes. As a 4-bit field, the maximum value is 15; this means that the maximum size of the IPv4 header is 15× 32 bits=480 bits=60 bytes.
Type of Service: 8-bit field indicating the priority of the packet and other quality of service (QOS) information.
Total Length: 16-bit field indicating the total length of the IP packet in bytes. This includes the header and the data.
Identification: 16-bit field for identifying the packet. This field is used by routers to fragment and reassemble packets.
Flags: 8-bit field that contains three flags
Reserved: Reserved for future use.
Don't Fragment: A bit indicating the packet should not be fragmented.
More Fragments: A bit indicating there are more fragments of the packet.
Fragment Offset: 13-bit field indicating the offset of the fragment in the original packet.
Time to Live (TTL): 8-bit field indicating the maximum number of hops that a packet can take through the network. The TTL is decremented by one by each router that handles the packet. If the TTL reaches zero, the packet is dropped.
Protocol: 8-bit field indicating the protocol that the packet is carrying.
Header Checksum: 16-bit field for verifying the integrity of the IP header. The checksum is calculated by adding up all of the 16-bit words in the header and then taking the two's complement of the result.
Source IP Address: 32-bit field indicating the IP address of the source of the packet.
Destination IP 32-bit field indicating the IP address of the
Address: destination of the packet.
Options: An optional field, if present, can contain additional information about the datagram, such as security options or routing instructions.

An IPv6 packet includes an IPv6 header and a payload. The IPv6 header includes two main components: a fixed header and optional extension headers.

The Fixed Header contains the following fields:
Version: 4-bit field indicating the IP protocol version, always set to 6 for IPv6.
Traffic Class: 8-bit field for differentiated services and quality of service (QOS) functionalities.
Flow Label: 20-bit field identifying a specific traffic flow for special handling.
Payload Length: 16-bit field specifying the total length of the payload in bytes.
Next Header: 8-bit field indicating the type of the next header, either an extension header or the upper-layer protocol.
Hop Limit: 8-bit field setting the maximum number of hops a packet can travel before being discarded.
Source Address: 128-bit field containing the sender's IPv6 address.
Destination 128-bit field containing the recipient's IPv6
Address: address.

The extension headers can be added after the fixed header to provide additional functionalities. The additional functionalities include headers like Hop-by-Hop Options, Routing, Fragment, Destination Options, and Authentication. Each extension header contains a Next Header field indicating the type of the following header.

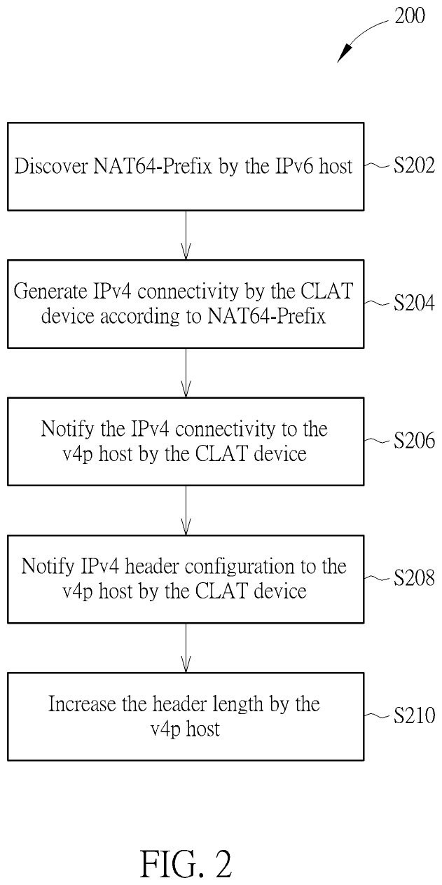

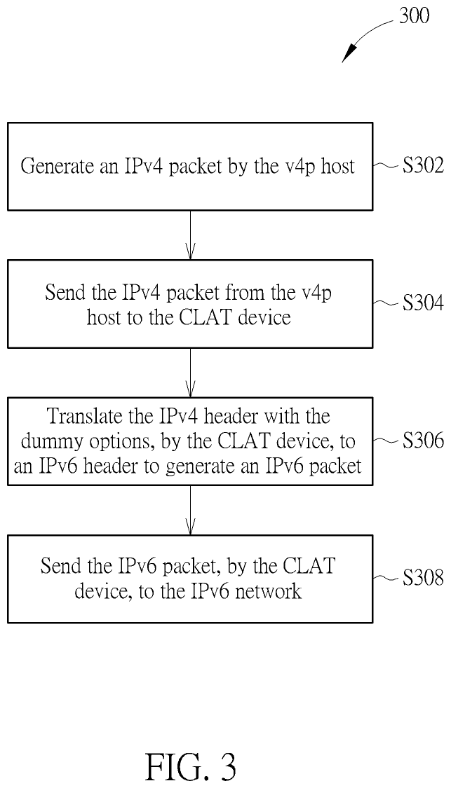

FIGS. 2 and 3 are flowcharts illustrating methods of NAT64 translation implemented in accordance with the NAT64 translation system 100.

The method 200 in FIG. 2 depicts steps for device setup. The method 200 includes the following steps:
S202: Discover NAT64-Prefix by the IPv6 host 106;
S204: Generate IPv4 connectivity by the CLAT device 102 according to NAT64-Prefix;
S206: Notify the IPv4 connectivity to the v4p host 104 by the CLAT device 102;
S208: Notify IPv4 header configuration to the v4p host 104 by the CLAT device 102; and
S210: Increase the header length by the v4p host 104.

The IPv4 header configuration conveys information about the header of an IPv4 packet. Furthermore, in steps S204 and S206, the CLAT device 102 may configure IPv4 private address to TCP/IP stack to facilitate IPv4 sockets, so that any IPv4 socket bound to CLAT device 102 may modify Internet Header Length (IHL) to be 12 (instead of 5). As a result, the IPv4 header length may be increased to 48 bytes by filling in with dummy options, and the TCP stack can create payloads that do not require fragmentation.

In more detail, the CLAT device 102 uses DNS64 or Router advertisement to identify translation rule from IPv4 address to IPv6 address and vice versa. Once the translation rule is setup, the CLAT device 102 may generate a private IPv4 address and notify IPv4 route to v4p host 104 along with the private IPv4 address. This is referred to as IPv4 connectivity, which allows an IPv4 agent to select a source IPv4 address and create a socket to connect to a remote IPv4 address without any knowledge of IPv6-only network. The CLAT device 102 handles the device under test (DUT) side translation to convert IPv4 packets to IPv6 packets and send them to IPv6 network 106. At a remote side, a provider-side translator (PLAT) may translate IPv6 packets to IPv4 packets and forward to a remote IPv4 server. Thus, this allows seamless connectivity between IPv4 hosts across IPv6 only internet.

The method 300 in FIG. 3 depicts steps for packet transmission. The method 300 includes the following steps:
S302: Generate an IPv4 packet by the v4p host 104;
S304: Send the IPv4 packet from the v4p host 104 to the CLAT device 102;
S306: Translate the IPv4 header with the dummy options, by the CLAT device 102, to an IPv6 header to generate an IPv6 packet; and
S308: Send the IPv6 packet, by the CLAT device 102, to the IPv6 network 106.

The IPv4 packet includes the IPv4 header with the dummy options, and the payload. The IPv6 packet includes the IPv6 header and the payload.

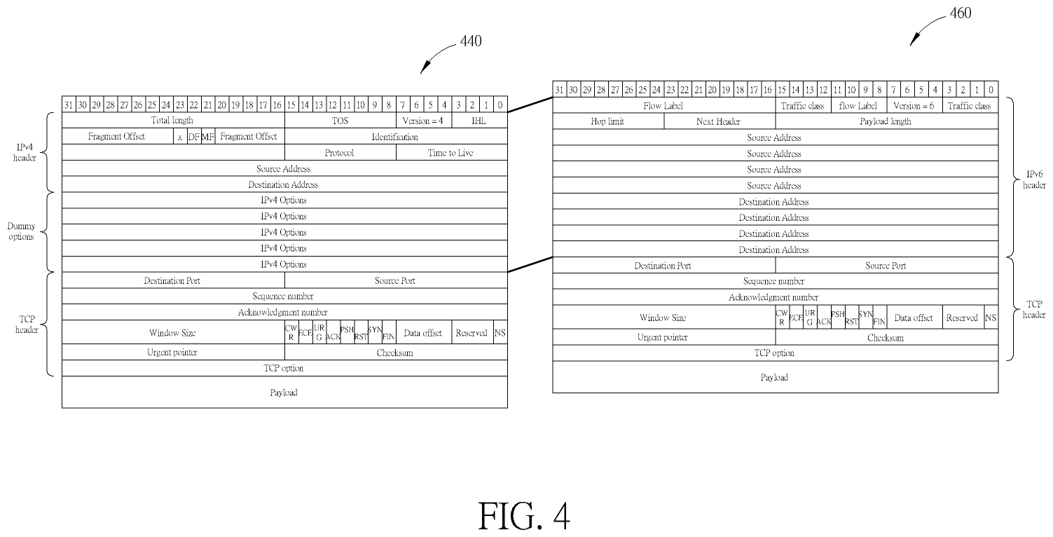

FIG. 4 is a diagram illustrating an exemplary translation of an IPv4 packet to an IPv6 packet of an embodiment. The IPv4 packet 440 may include a 20-byte IPv4 header and 28-byte dummy options. It may also include a TCP header and a payload. The IPv6 packet 460 may include a 40-byte IPv6 header, the same TCP header and the same payload.

The IPv4 packet 440 may be translated to the IPv6 packet 460 through the above described method. That is, the 20-byte IPv4 header and the 28-byte dummy options may be translated to the IPv6 header.

The details of the packet headers have been described in the above paragraphs, and will not be repeated herein for brevity.

The IPv6 header may be 40-bytes in header length (shorter than the 48-byte IPv4 header length). In some embodiments, packet buffer offset techniques can be applied to write IPv6 header with 8-byte offset to compensate for the length difference. In some embodiments, an 8-byte fragmentation header can be generated with the IPv6 header to fill the 48-byte length.

The IPv4 packet may have a checksum-neutral address as defined in RFC 6052. By selecting the checksum-neutral address, the payload and the TCP header would not require modification during the translation. This can reduce read and write operations and checksum re-evaluation.

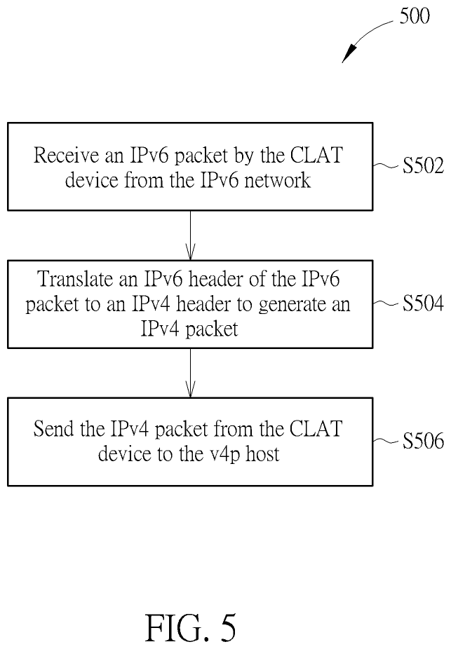

FIG. 5 is a flowchart illustrating a method 500 of NAT64 translation implemented in accordance with the NAT64 translation system 100. The method 500 in FIG. 5 depicts steps for packet reception. The method 500 includes the following steps:
S502: Receive an IPv6 packet by the CLAT device 102 from the IPv6 network 106;
S504: Translate an IPv6 header of the IPv6 packet, by the CLAT device 102, to an IPv4 header to generate an IPv4 packet; and
S506: Send the IPv4 packet from the CLAT device 102 to the v4p host 104.

In method 500, no special packet structuring is required as packet buffer offset techniques can be applied to create IPv4 packet with header length of 20 bytes. For example, the offset may be 20 bytes or 28 bytes depending on the implementation. Thus, the received IPv4 packets can still have 20-byte header.

In some embodiments, the received IPv4 packet may have header length of 40 bytes or 48 bytes depending on the implementation.

To summarize, the various embodiments provide a method of improved NAT64 translation. This disclosed method can reduce the need for memory read and write operations, improve translation speed, and reduce memory requirement for buffer translator function.

The UE as described in this disclosure may include a device with radio communication capabilities. For example, the UE may include a smartphone (e.g., handheld touchscreen mobile computing devices connectable to one or more cellular networks). The UE may also include any mobile or non-mobile computing device, such as Personal Data Assistants (PDAs), pagers, laptop computers, desktop computers, wireless handsets, or any computing device that has a wireless communications interface.

The UE may also be referred to as a client, mobile device, mobile terminal, user terminal, mobile unit, mobile station, mobile user, subscriber, user, remote station, access agent, user agent, receiver, radio equipment, reconfigurable radio equipment, or reconfigurable mobile device. The UE may include IoT UE, which can include a network access layer designed for low-power IoT applications utilizing short-lived UE connections. IoT UE can utilize technologies (e.g., M2M, MTC, or mMTC technology) for exchanging data with an MTC server or device via a PLMN, other UEs using ProSe or D2D communications, sensor networks, or IoT networks. The M2M or MTC exchange of data may be a machine-initiated exchange of data. An IoT network describes interconnecting IoT UE, which may include uniquely identifiable embedded computing devices (within the Internet infrastructure). The IoT UE may execute background applications (e.g., keep-alive messages, status updates, etc.) to facilitate the connections of the IoT network.

The terms “coupled”, “connected”, “connecting”, “electrically connected”, etc., are used interchangeably herein to generally refer to the condition of being electrically connected (through wire or wireless means). Similarly, a first entity is considered to be in “communication” or “connection” with a second entity (or entities) when the first entity electrically sends and/or receives (through wire or wireless means) information signals (containing voice information or non-voice data/control information) to/from the second entity regardless of the type (analog or digital) of those signals. It is further noted that various figures (including component diagrams) shown and discussed herein are for illustrative purpose only, and are not drawn to scale.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The various illustrative logical blocks, modules, processors, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

The various embodiments described above may be implemented by one or more computers. In further detail, software and hardware hybrid implementations of at some of the embodiments disclosed may be implemented on a programmable network resident device (which should be understood to include intermittently connected network-aware device) selectively activated or reconfigured by a computer program stored in memory. Such network devices may have multiple network interfaces that may be configured or designed to utilize different types of network communication protocols. A general architecture for some of these devices may be disclosed herein in order to illustrate one or more examples by which a given unit of functionality may be implemented. In some embodiments, at least some of the features or functionalities disclosed herein may be implemented on one or more general-purpose computers associated with one or more networks, such as an end-user computer system, a client computer, a network server or other server system, a mobile computing device (e.g., tablet computing device, mobile phone, smartphone, laptop, and the like), a consumer electronic device or any other suitable electronic device, or any combination thereof. In some embodiments, at least some of the features or functionalities of the various embodiments disclosed may be implemented in one or more virtualized computing environments (e.g., network computing clouds, virtual machines hosted on one or more physical computing machines, or the like).

In some embodiments, the computing instructions may be carried out by an operating system, for example, Microsoft Windows™, Apple Mac OS/X or iOS operating systems, some variety of the Linux operating system, Google Android™ operating system, or the like.

In some embodiments, the computers may be on a distributed computing network, such as one having any number of clients and/or servers. Each client may run software for implementing client-side portions of the embodiments. In addition, any number of servers may be provided for handling requests received from one or more clients. Clients and servers may communicate with one another via one or more electronic networks, which may be in various embodiments such as the Internet, a wide area network, a mobile telephone network, a wireless network (e.g., Wi-Fi, 5G, and so forth), or a local area network. Networks may be implemented using any known network protocols.

For situations in which the systems discussed above collect information about users, the users may be provided with an opportunity to opt in/out of programs or features that may collect personal information (e.g., information about a user's preferences or usage of a smart device). In addition, in some implementations, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized (for example, generalized based on user demographics) rather than associated with a particular user.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Although some of various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of NAT64 translation comprising:
discovering NAT64-Prefix by an IPv6 host;
generating IPv4 connectivity by a customer-side translator (CLAT) device according to NAT64-Prefix;
notifying the IPv4 connectivity to a private IPv4 (v4p) host;
notifying IPv4 header configuration to the v4p host by the CLAT device, the IPv4 header configuration comprising a header length; and
increasing the header length by the v4p host.

2. The method of claim 1, wherein the header length is increased to 48 bytes.

3. The method of claim 1 further comprising waking up IPv6 only interface of the CLAT device.

4. The method of claim 1 further comprising:
generating an IPv4 packet by the v4p host, wherein the IPv4 packet comprising an IPv4 header with dummy options and a payload;
sending the IPv4 packet from the v4p host to the CLAT device;
translating the IPv4 header with the dummy option, by the CLAT device, to an IPv6 header to generate an IPv6 packet; and
sending the IPv6 packet, by the CLAT device, to an IPv6 network.

5. The method of claim 4, wherein the IPv6 packet comprises the IPv6 header and the payload.

6. The method of claim 4, wherein the IPv4 packet further comprises a checksum-neutral address.

7. The method of claim 1 further comprising:
generating an IPv4 packet by the v4p host, the IPv4 packet comprising an IPv4 header with dummy options and a payload;
sending the IPv4 packet from the v4p host to the CLAT device;
translating the IPv4 header and the dummy option to an IPv6 header and a fragmentation header, by the CLAT device, to generate an IPv6 packet; and
sending the IPv6 packet, by the CLAT device, to an IPv6 network.

8. The method of claim 7, wherein the IPv6 packet comprises the IPv6 header, the fragmentation header and the payload.

9. The method of claim 7, wherein the IPv6 packet further comprises a checksum-neutral address.

10. The method of claim 1 further comprising:
receiving an IPv6 packet by the CLAT device from an IPv6 network;
translating an IPv6 header of the IPv6 packet to an IPv4 header to generate an IPv4 packet; and
sending the IPv4 packet from the CLAT device to the v4p host.

11. The method of claim 10, wherein the IPv6 packet comprises a checksum-neutral address.

12. A method of NAT64 translation comprising:
generating an IPv4 packet by a private IPv4 (v4p) host, the IPv4 packet comprising an IPv4 header with dummy options and a payload;
sending the IPv4 packet from the v4p host to a customer-side translator (CLAT) device;
translating the IPv4 header and the dummy option to an IPv6 header, by the CLAT device, to generate an IPv6 packet; and
sending the IPv6 packet, by the CLAT device, to an IPv6 network.

13. The method of claim 12, wherein the IPv6 packet comprises the IPv6 header and the payload.

14. The method of claim 12, wherein the IPv4 packet further comprises a checksum-neutral address.

15. A method of NAT64 translation comprising:
generating an IPv4 packet by a private IPv4 (v4p) host, the IPv4 packet comprising an IPv4 header with dummy options and a payload;
sending the IPv4 packet from the v4p host to the customer-side translator (CLAT) device;
translating the IPv4 header and the dummy option to an IPv6 header and a fragmentation header to generate an IPv6 packet; and
sending the IPv6 packet to an IPv6 network.

16. The method of claim 15, wherein the IPv6 packet comprises the IPv6 header, the fragmentation header and the payload.

17. The method of claim 15, wherein the IPv4 packet further comprises a checksum-neutral address.
